(19) United States
(12) Patent Application Publication
(10) Pub. No.: US 2007/0255443 A1
(43) Pub. Date: Nov. 1, 2007

(54) SYSTEM AND METHOD FOR AUTOMATICALLY DISTRIBUTING MATERIALS

(75) Inventors: Duo Liu, Shenzhen (CN); Shang-Qing Wang, Shenzhen (CN); Hai-Sen Liang, Shenzhen (CN); Hua-Dong Cheng, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/617,700

(22) Filed: Dec. 28, 2006

(30) Foreign Application Priority Data
Apr. 28, 2006 (CN) 200610060514.1

(51) Int. Cl. G06F 19/00

(52) U.S. Cl. 700/115

(57) ABSTRACT

A method for distributing materials to corresponding production lines is provided. The method includes: receiving an identification code of the materials transmitted from the scanner; querying the production line of the material by searching for the identification code in material-production line table that lists the identification codes and the production lines accordingly; and controlling an indication device to indicate the corresponding production line.

### BACKGROUND OF THE INVENTION

1. Technical Field

The present invention relates generally to a system and method for automatically directing production lines which materials are distributed to.

2. General Background

Generally, different products are manufactured to different production lines and therefore materials to the different production lines are different. Each type of the materials has been assigned with an exclusive identification code. The exclusive identification code contains information about the materials such as name, class, and package form. The identification code can be a PN/SN (product number/serial number) from that people can directly obtain information on the materials or a bar code that is only recognized by a computer. Commonly, a manual distribution process is employed to distribute the materials, the manual distribution process depends on people to infer from the PN/SN of the materials and determine which production line the materials is distributed to and therefore easily to make mistakes during the manual distribution process, especially when the materials to be distributed have a same name as another type of materials.

Therefore what is needed is a system and method that can automatically direct production lines which materials are distributed to.

### SUMMARY

A system for distributing materials to corresponding production line is provided. A preferred embodiment of the system includes a scanner, a computer, and a controller, the scanner being provided for scanning identification codes of materials into the computer. The computer Includes a data storage and a CPU. The data storage is for storing a material-production line table that lists the identification codes and the production lines accordingly. The CPU (centre processing unit) includes an identification code receiving module, a production line determining module, and an indication device control module. The identification code receiving module is for receiving an identification code of materials transmitted from the scanner. The production line determining module is for querying the production line of the material by searching for the identification code in material-production line table e. The indication device control module is for sending a control signal to the controller to control an indication device to indicate the corresponding production line.

A method for distributing materials to corresponding production lines is provided. The method includes: receiving an identification code of the materials transmitted from the scanner; querying the production line of the material by searching for the identification code in material-production line table that lists the identification codes and the production lines accordingly; and controlling an indication device to indicate the corresponding production line.

Other advantages and novel features will be drawn from the following detailed description of the preferred embodiment with reference to the attached drawings, in which:

### BRIEF DESCRIPTION OF THE DRAWINGS

FIG. 1 is a hardware infrastructure diagram of a system for distributing materials in accordance with a preferred embodiment of the present invention;

FIG. 2 is a function module diagram of a CPU of a computer of FIG. 1; and

FIG. 3 is a flow chart of distributing materials.

### DETAILED DESCRIPTION OF THE PREFERRED EMBODIMENT

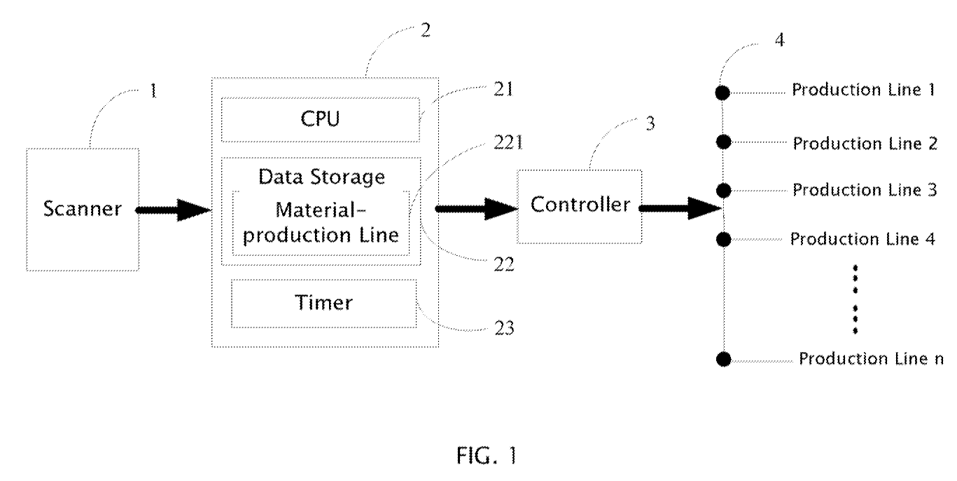

FIG. 1 is a hardware infrastructure diagram of a system for distributing materials in accordance with a preferred embodiment of the present invention. The system includes a scanner 1, a computer 2, a controller 3, and one or more indication devices 4, each of the indication devices 4 corresponding to a production line. The scanner 1 and the controller 3 connect to the computer 2 via digital interfaces. The controller 3 is further connected with the indication devices 4. The indication devices 4 can be LED lamps.

The scanner 1 is configured for scanning identification codes of materials into the computer 2. In the preferred embodiment of this invention, the identification codes the scanner 1 scans into the computer 2 are bar codes.

The computer 2 includes a data storage 21, a CPU (centre processing unit) 22, and a timer 23. The data storage 21 stores a material-production line table 211 that lists the identification codes and the production lines accordingly. In this preferred embodiment, materials to be distributed to different production lines come from different countries and are wholly taken as an example to describe how to automatically distribute the materials. In this preferred embodiment the bar codes of the material includes country codes. The country codes indicate country of origin of the materials. Relationships between the countries and the production lines the materials are to be distributed at are shown in the following Table 1.

TABLE 1

| | Production Line | |
|---|---|---|
| Country code | Code | Production Line |
| 01 (France) | 001 | Production Line 1 |
| 02 (England) | 010 | Production Line 2 |
| 03 (German) | 011 | Production Line 3 |
| 04 (America) | 100 | Production Line 4 |
| 05 (Japan) | 101 | Production Line 5 |

In Table 1, the material-product line table contains a Country Code column, a Production Line Code column, and a Production Line column. Each row in the table corresponds to the Country of origin of the material, the production line code of the material, and the production line of the material according to the Country code, the Production Line Code, and the Production Line respectively.

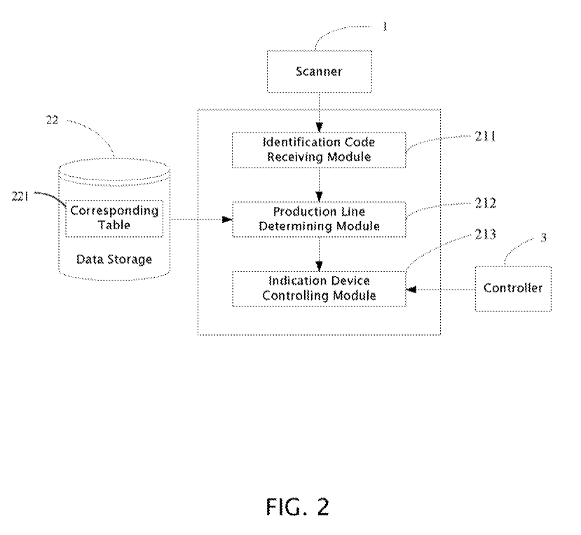

Referring together to FIG. 2, the CPU 22 includes an identification code receiving module 211, a production line determining module 212, and an indication device control module 213. The identification code receiving module 211 is for receiving the identification code of the materials transmitted from the scanner 1. The production line determining module 212 is for querying the production line of the material by searching for the identification code in material-production line table. The indication device control module 213 is for sending a control instruction to the controller 3 signaling the indication device 4 to indicate the production line of the material. With the aide of the indication device 4 operators are able to recognize the production line of the material.

In this preferred embodiment, the controller 3 can be a 3-to-8 line decoder including three inputs and eight outputs. The inputs of the 3-to-8 line decoder are correspondingly connected to three pins of a parallel interface of the computer 2 and the outputs of the 3-to-8 line decoder are respectively connected to the indication devices 4. In table 1, the production line codes recorded in “Production Line code” column is encoded according to the different input of the three input of the 3-to-8 line decoder.

The timer 12 starts a time when the computer 2 sends the control signal to the controller 3 and informs the computer 2 when the time reaches a predetermined time. The computer 2 then sends a control signal to the controller 3 to power off the indication device 4. For example, the computer can input a control signal “000” to the controller to power off the indication device 4.

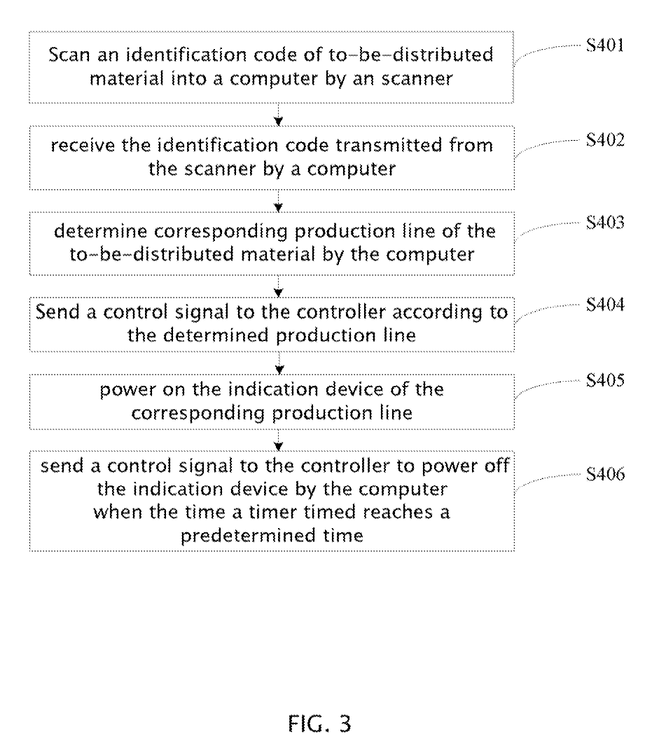

FIG. 3 is a flow chart of distributing materials to a corresponding production line. In step S401, the scanner 1 scans the identification code of the materials into the computer 2.

In Step S402, the computer 2 receives the identification code transmitted from the scanner 1.

In step S403, the computer 2 queries the production line of the material by searching for the identification code in material-production line table.

In step S404, the computer sends a control instruction to the controller 3 signaling the indication device 4 to indicate the production line of the material.

In step S405, the controller 3 powers on the indication device 4 of the corresponding production line according to the control instruction transmitted from the computer 2.

In step S406, the timer 23 starts a time when the computer 2 sends the controlling instruction to the controller 3 and informs the computer 2 when the time reaches a predetermined time.

In step S407, the computer 2 sends a control signal to the controller 3 to power off the indication device 4.

Although the present invention has been specifically described on the basis of a preferred embodiment, the invention is not to be construed as being limited thereto. Various changes or modifications may be made to the embodiment without departing from the scope and spirit of the invention.

What is claimed is:

1. A system for distributing materials to corresponding production line, comprising a scanner, a computer, and a controller, the scanner being provided for scanning identification codes of materials into the computer, wherein:
the computer comprises:
a data storage for storing a material-production line table that lists the identification codes and the production lines accordingly; and
a CPU (centre processing unit), comprising:
an identification code receiving module for receiving an identification code of the materials transmitted from the scanner;
a production line determining module for querying the production line of the material by searching for the identification code in material-production line table; and
an indication device control module for sending a control instruction to the controller signaling the indication device to indicate the production line.

2. The system as described in claim 1, wherein the controller is a 3-to-8 line decoder.

3. The system as described in claim 1, the computer further comprises a timer, wherein the timer starts a time when the indicate device powered on, and informs the computer to send a control signal to the controller to power off the indication device when the time reaches a predetermined time.

4. A method for distributing materials to corresponding production lines, comprising:
receiving an identification code of the materials transmitted from the scanner;
querying the production line of the material by searching for the identification code in material-production line table that lists the identification codes and the production lines accordingly; and
controlling an indication device to indicate the corresponding production line.

5. The method as described in claim 4, further comprising the step of starting a timing when the indication device is powered on, and powering off the indication device when the timing reaches a predetermined time.
